(19) United States
(12) Patent Application Publication
(10) Pub. No.: US 2003/0027641 A1
(43) Pub. Date: Feb. 6, 2003

(54) Universal joint and coupling assembly

(76) Inventor: James K. Parsons, New Tazewell, TN (US)

Correspondence Address: M. Alex Brown, Esq., Patent Attorney, P.O. Box 70501, Knoxville, TN, 37938-0501, US

(21) Appl. No.: 09/907,144

(22) Filed: Jul. 16, 2001

(51) Int. Cl. F16D 3/16; F16D 3/34; F16D 3/44; F16D 3/50

(52) U.S. Cl. 464/139

(57) ABSTRACT

A universal joint and coupling assembly is disclosed which is utilized to connect and transfer power or movement between at least two movable or moving members which respectively have different positional planes, orientations or movement axes. The invention is provided with a novel channeled spherical or ball-like guide connection member for greater angle positioning along less wearable surfacing. This guide connection member functions both to secure support attachment components which are a part of or connect to one or more moving members, and to securely allow movement through secure channeling and tracking of each of the support attachment components onto the guide connection member.

### BACKGROUND OF THE INVENTION

1. Field of the Invention

The present invention relates to apparatus, methods and systems for providing a universal and coupling joint for transferring movement form one plane or position to another plane or position, as a part of a mechanical, automotive and/or vehicle system, device or apparatus.

2. Background Information

There have been many types of universal joints and coupling member joints that have been developed and/or patented over the years. The prior art found during the process of a search, regarding this crowded technology; included the following United States patents: Schmudde et at., U.S. Pat. No. 5,851,082; Lynch et al., U.S. Pat. No. 5,816,926; Gall et al., U.S. Pat. No. 5,647,799; Cornay, U.S. Pat. No. 5,425,676, Jacob et al., U.S. Pat. No. 5,376,052; Duphily, U.S. Pat. No. 5,407,385; Sakal, U.S. Pat. No. 5,284,398; Hazebrook, Re. No. 32,830; Sawada et al., U.S. Pat. No. 4,714,368; Talg et al., U.S. Pat. No. 4,395,246; Arnold, U.S. Pat. No. 3,587,249; Oppenhelmer, U.S. Pat. No. 3,525,543; Meyer, U.S. Pat. No. 3,392,548; Williams, U.S. Pat. No. 1,835,684; Harel, U.S. Pat. No. 1,826,662; Rzeppa, U.S. Pat. No. 1,665,280; Ream, U.S. Pat. No. 1,297,968 and U.S. Pat. No. 1,225,174; Walters, U.S. Pat. No. 956,912; Shaw, U.S. Pat. No. 899,913; and Johnston, U.S. Pat. No. 243,914.

The Schmudde '082, Lynch '926, Cornay '676, Sawada '368, Taig '246, Williams '684, Walters '919, Shaw '913, Johnston '914, Harel '662 and Meyer '548 patent references teach inventions which were patented, going back to the year 1881. The teachings, in this regard, set forth inventions which are based on various adaptations of the ball-and-socket approach to universal coupling members.

The Harel '662 reference sets forth a “Universal Joint” having a rib element on a ball member and a cooperating groove element on the joint member of this invention, rather than a multiple grooved ball member and a cooperating plurality of slidably interlocking guide support members, as is the case in the present invention.

The Meyer '548 reference sets forth its entitled invention: “Constant Velocity Universal Joints”, in which its ball element is secreted inside a typical joint member. Its first shaft has a socket member and a number of straight or linear contact members which project outwardly, and its second shaft has a ball member oriented inwardly and a number of curved contact Members which apparently rest on, and move in relation to its respective cooperating straight or linear contact members. Meyer is very different, structurally and functionally, to the grooved ball or spherical positional guide member and slidably interlocking guide support members of the present invention; and, therefore, functions in its movement, in a very different manner to that of the present invention.

The Jacob '052 reference is entitled a “Fixed Constant Velocity Joint”; and sets forth another adaptation of the ball and socket principal, where a number of interfacing bearings are utilized internally to facilitate movement between its first and second shafts. The Gall '799 reference sets forth a “Bearing Cap For Universal Joint Having Anti-Rotation Protrusions”, and is one of the more conventional designs being utilized in this crowded technology in today's marketplace. Both the Jocob '052 and the Gall '799 references are substantially distinguishable, structurally and functionally from the present invention; as indicated in the review of FIG. 1 of Gall and FIGS. 1, 2, 4, 5 and 6 of Jacob.

The Sakai '398, Hazelbrook '830, Arnold '249, Rzeppa '280, and Ream '968 and '174 references set forth various adaptations and designs for universal joints or coupling members which are distinguishable from the present invention; and which have involved a number of operational problems in the past.

The Ream '968 patent reference; entitled “Universal Joint”; teaches a universal joint having a cup shaped member and a flexible member movably mounted in the cup member. This flexible member comprises a shaft having a spherical body portion within the cup member and provided with a number of radially extending concentric cogs having ‘convexed’ sides (somewhat similar to the Meyer '548 reference, previously discussed, in this specific respect). Ream further teaches a number of concentrically formed segments which it claims are interlocked with its cup member, and provided on their inner sides with cone shaped rollers in engagement with its cogs on the flexible member; and a concentrically formed locking ring interlocked with its segments and adapted to hold the body portion of the flexible member in its cup member. This is very different, structurally and functionally, in its movement design, to the elements of the present invention.

The Rzeppa '280 reference, entitled “Universal Joint”, teaches a very different structure; having, in combination with a pair of shafts, a universal connection unit for such shafts, comprising an outer ball race member and an inner ball race member, these members provided with registering curved ball receiving grooves, a ball cage between the members, balls carried by the cage within the grooves of the race members to lock the members to rotate together, a socket on one shaft receivable over the universal connection unit and means to lock the outer ball race member thereto to rotate therewith, and a part on the other shaft engageable within the inner race member to lock it to rotate therewith. The Rzeppa invention is very different structurally; and functions very differently in its movable and cooperating parts.

The Hazelbrook '830 reference, entitled “Method Of Forming A Precision Ball Track”, discloses a machining method for creating a groove for interfacing with bearing members. This method is functionally distinguishable from the movement functions of the cooperating spherical positional guide member and the guide support members of the present invention; and produces, and is designed to produce a product, which is structurally different from either the positional guide member or the guide support members of the present invention. the review of FIG. 1 of Gall and FIGS. 1, 2, 4, 5 and 6 of Jacob.

The Sakai '398, Hazelbrook '830, Arnold '249, Rzeppa '280, and Ream '968 and '174 references set forth various adaptations and designs for universal joints or coupling members which are distinguishable from the present invention; and which have involved a number of operational problems in the past.

The Ream '968 patent reference; entitled “Universal Joint”; teaches a universal joint having a cup shaped member and a flexible member movably mounted in the cup member. This flexible member comprises a shaft having a spherical body portion within the cup member and provided with a number of radially extending concentric cogs having ‘convexed’ sides (somewhat similar to the Meyer '548 reference, previously discussed, in this specific respect). Ream further teaches a number of concentrically formed segments which it claims are interlocked with its cup member, and provided on their inner sides with cone shaped rollers in engagement with its cogs on the flexible member; and a concentrically formed locking ring interlocked with its segments and adapted to hold the body portion of the flexible member in its cup member. This is very different, structurally and functionally, in its movement design, to the elements of the present invention.

The Rzeppa '280 reference, entitled “Universal Joint”, teaches a very different structure; having, in combination with a pair of shafts, a universal connection unit for such shafts, comprising an outer ball race member and an inner ball race member, these members provided with registering curved ball receiving grooves, a ball cage between the members, balls carried by the cage within the grooves of the race members to lock the members to rotate together, a socket on one shaft receivable over the universal connection unit and means to lock the outer ball race member thereto to rotate therewith, and a part on the other shaft engageable within the inner race member to lock it to rotate therewith. The Rzeppa invention is very different structurally; and functions very differently in its movable and cooperating parts.

The Hazelbrook '830 reference, entitled “Method Of Forming A Precision Ball Track”, discloses a machining method for creating a groove for interfacing with bearing members. This method is functionally distinguishable from the movement functions of the cooperating spherical positional guide member and the guide support members of the present invention; and produces, and is designed to produce a product, which is structurally different from either the positional guide member or the guide support members of the present invention.

The Duphily '385 patent reference, entitled “Steered And Driven Universal Joint” discloses a very different structural Component; having a ball member that actually rotates on its cooperating axle, which is provided with certain rib-type parts (somewhat similar to the Shaw '918 reference of 1908), to engage and fit within shoes, each having a groove for this fitting. The ball of Duphily, therefore, moves with its attached axle, in distinction to the present invention, and engages another moveable member, and its surface, through utilization of very different structural members.

None of the references found in the prior art specifically illustrate or disclose the Universal Joint And Coupling Assembly of the present invention. Nor is the present invention obvious in view of any of the prior art references listed. In addition, all of the relevant prior art heretofore known suffer from a number of disadvantages.

None of the, apparently, crowded, prior art references teach concepts of invention which provide a relatively simple, and easy to manufacture Universal Joint and Coupling Assembly which can easily be pivoted and moved along a wider range of pre-existing manufactured positions for ease and efficiency in transferring movement form one plane or position to another (and from one movable member to another such member).

In the past, the prior art shows that many problems in design and complexity of structural construction, and inter-relation of parts, have been associated with attempting to provide a ‘user-friendly’ universal joint assembly, which was readily and reasonably amenable and functional in the inter-change and replacement of working and movable parts and securing members.

Also, none of the prior art devices in this area of technology have utilized the concept of providing the efficiency and simplicity of engaging a sole channeled, spherical position guide member for tracking and securely guiding support attachment members for receiving and transferring movement from, and between, positional planes.

Additionally, the prior art has not been shown to provide a universal joint assembly which can provide great strength and security, while also providing the functional ability to releasably exchange important movement engaging parts.

Also, none of the prior art devices provide, in their manufacture, for the ability, and method, of efficiently and cost-effectively producing a universal joint and coupling assembly product such as the present invention.

The prior art devices also have a number of design problems in adequately or properly providing for lubrication or the ability and accessible areas to provide such lubrication; and many of the prior art devices require considerably more lubrication means, in order to properly function. The prior art also fails in construction by providing too much wearable surfacing for moveable parts.

Further, the prior art devices function only to generate movement through an angle Of only about 20 degrees.

These and other disadvantages, structurally and functionally, of the prior art will become apparent in reviewing the remainder of the present specification, claims and drawings.

Accordingly, it is an object of the present invention to provide a substantially improved universal joint and coupling assembly having substantially enhanced and less complicated structure and versatility of use with regard to the many different applications that the present invention can be utilized; such as in assisting in the many diverse uses in the operation and steering of an automobile, tractor, plane, boat, spaceship or other land, air, sea or space vehicle, craft, ship or space craft or vehicle.

It is a further object of the present invention to provide a universal joint assembly which is provided with secure and strong, yet releasable and interchangeable parts; and for the interchange of such parts through ‘user-friendly, easier access areas, as a part of the present invention's structural advantages regarding its spherical guiding and tracking member and its interconnecting and inter-sliding support and connection members; thus presenting a more efficient and accessible universal and coupling assembly device.

A further object of the present invention is to provide a universal joint and coupling assembly which is more simple and efficient, yet stronger, more versatile and secure in structural and functional design; with regard to its positioning, guiding and movement transfer elements or members; and which provides a superior design in the structural use of a channeled guide sphere or ball and its cooperating, positioned, arcuate support attachment members.

Another important object of the present invention is to provide a universal joint with less wearable surfacing and the structural ability to position to, and generate movement through, angles of 25 to 30degrees and greater while providing secure attachment and support of releasable and replaceable parts.

It is yet a further object of the present invention to provide a substantially improved, and novel, process and method for fabricating and manufacturing the universal joint and coupling assembly of the present invention; and for retro-fitting the attachment parts or members that the present invention will interact with in providing and transferring movement.

It will, therefore, be understood that substantial and distinguishable structural and functional advantages am realized in the present invention over the prior art devices; and that the present invention's simplicity of structure, diverse utility, and broad functional applications serve as important bases of novelty and distinction in this regard, over the prior art in this crowded technology.

### SUMMARY OF THE INVENTION

The foregoing and other objects of the invention can be achieved with the present invention, device, system and assembly which is a universal and coupling assembly for use in connecting a plurality of connection members to one another, for transfer of movement, therebetween; and from at least one positional plane to another position-a plane, therebetween. The invention is provided with a spherical positional guide member, positionally oriented to interface between, and connect, a plurality of connection members. The spherical positional guide member defines and is provided with a channeled and grooved outer periphery surface, having a plurality of channels. Each of the plurality of channels is defined and set in relation to one another along an arcuate and circumferential periphery. The invention is further provided with a plurality of guide support members. Each of these guide support members is slidably and positionally oriented in relation to at least one of the respective channels, and attached to at least of a plurality of connection members which provide or receive movement impetus or force, and, with which, the present invention interacts.

### BRIEF DESCRIPTION OF THE DRAWINGS

FIG. 1 is a side view of one preferred embodiment of the novel Universal Joint and Coupling Assembly of the present invention

FIG. 2 is a side of the Universal of FIG. 1 turned about 45 degrees from the positioning of FIG. 1.

FIG. 3 is an exemplar top new (or top cross-sectional new) of the connection member utilized in interaction or combination with the Universal of FIG. 1.

FIG. 4 is an exemplar top view (or top cross-sectional view) of another connection member utilized in interaction or combination with the Universal of FIG. 1.

FIG. 5 is an inverted bottom perspective view of the Universal of FIG. 2, showing broken lines to illustrate underlying (or not otherwise viewable) elements of the present invention.

FIG. 6 is an elevated perspective view of the Universal of FIG. 2, showing broken lines to illustrate underlying elements of the invention.

FIG. 7 is an enlarged scale partial or fragmentation view of the Universal, similar to that of FIG. 5, set forth for clarification of detail of the present invention.

FIG. 8 is an enlarged scale partial view of the Universal of FIG. 6, showing broken lines to illustrate other underlying elements of the invention.

FIG. 9 is an exemplar front view of one of the guide support members utilized in a preferred embodiment of the Universal of the present invention, the back view being a mirror image thereof.

FIG. 10 is a top view of one preferred embodiment of the novel positional guide member of the Universal of the present invention.

FIG. 11 is an exemplar front perspective of one of the wear pad silencer members, utilized in one preferred embodiment of the Universal of the present invention.

FIG. 12 is an exemplar top plan view of one of the retainer ring members, of a preferred embodiment of the Universal of the present invention.

FIG. 13 is an exemplar side perspective of the retainer ring of the Universal of FIG. 12.

FIG. 14 is a partial side view of a connection member, retrofitted (or retro-dimensioned) in preferred embodiments of the present invention, showing broken tines to illustrate part of the machining process of the Universal of the present invention.

FIG. 15 is a partial side view of a connection member, retrofitted in preferred embodiments of the invention, showing broken lines to illustrate underlying machining elements of the present invention.

FIG. 16 is an exemplar top plan view of a retrofitted connection member of the Universal of the present invention.

FIG. 17 is a partial bottom perspective of a retrofitted connection member of preferred related embodiments of the present invention, showing broken lines to illustrate part of the machining process encompassed within the present invention.

FIG. 18 is a partial elevated perspective of a retrofitted connection member of preferred embodiments of the present invention, showing broken lines to illustrate further details of the underlying machining process of the present invention.

FIG. 19 is a partial elevated perspective of a retrofitted connection member of preferred embodiments of the present invention, showing broken lines to illustrate further details of the machining process of the present invention.

FIG. 20 is a side view of a retrofitted connection member of preferred embodiments of the present invention, showing broken lines to illustrate further details of the process of the present invention

FIG. 21 is a side view of a retrofitted connection member of preferred embodiments of the present invention, swing broken lines to illustrate further details of the process of the present invention.

FIG. 22 is a front view of another of the guide support members, of preferred embodiments of the Universal of the present invention, the back view being a mirror image thereof.

FIG. 23 is an elevated perspective of one of the retainer ring members of the present Universal being placed over and in juxtaposition with one of the wear pad silencer members of the present Universal of the present invention.

FIG. 23a is a partially exploded perspective view illustrating, in preferred embodiments of the present invention, a positional orientation or relationship one of the retainer ring members of the invention with one of the wear pad silencer members of the invention.

FIG. 24 is a front view of one of the guide support members in preferred embodiments of the Universal of the present invention illustrating fitting and install attachment of elements of the retainer subassembly system thereof, the broken lines showing the underlying, installed wear pad silencer member of the invention.

FIG. 25 is a bottom view of the positional guide member of the Universal of the present invention, of FIG. 10.

FIG. 26 is a side view of the positional guide member of the Universal of FIGS. 10 and 25, the adjacent side views (where the member is turned on the same axis about 45 degrees) being a mirror image thereof.

FIG. 27 is a further side view of the positional guide member of the Universal of FIGS. 10 and 25, further clarification, showing that the adjacent side views (where the member is turned on the same axis about 45 degrees) are mirror images.

FIG. 28 is a top view of one of the connection members utilized in combination or interaction with the Universal of the present invention, in another preferred embodiment of the present invention, illustrating the hollowed movement area thereof.

FIG. 30 is a partial side view of one embodiment of the Universal of the present invention, illustrating a side view of one of the embodiments of the hollowed movement area shown in FIG. 28.

REFERENCE NUMBERS IN DRAWINGS

| | |
|---|---|
| 10 | Universal and Coupling Assembly (or Universal) |
| 12 | positional guide member |
| 12a | curved or arcuate periphery surfacing of (12) |
| 14 | channel guide of (12) |
| 16 | channel guide of (12) |
| 18 | guide support member |
| 20 | guide support member |
| 21a | connection member |
| 21b | connection member |
| 22 | central curved portion of (18) |
| 24 | central curved portion of (20) |
| 26 | end portion of (18) |
| 28 | end portion of (18) |
| 30 | end portion of (20) |
| 32 | end portion of (20) |
| 23a | hollowed movement area of (21a) |
| 23b | hollowed movement area of (21b) |
| 40 | retainer subassembly means or system |
| 41a | port installation area of (21a) |
| 41b | port installation area of (21b) |
| 44 | installation notch of (26) |
| 46 | installation notch of (28) |
| 48 | installation notch of (30) |
| 50 | installation notch of (32) |
| 52 | retainer ring member of (40) on (18) |
| 54 | wear pad silencer member of (40) on (18) |
| 56 | retainer ring member of (40) on (20) |
| 58 | wear pad silencer member of (40) on (20) |
| 52a | outer channeled circumferential perimeter of (52) |
| 56a | outer channeled circumferential perimeter of (54) |
| 54a | depressed mid flange surfacing of (54) |
| 58a | depressed mid flange surfacing of (58) |
| 60 | set screw of (40) in (21a) |
| 62 | set screw of (40) in (21b) |
| 64 | set screw hole for (60) |
| 66 | set screw hole for (62) |
| 68 | flange channeled portion of (41a) |
| 70 | flange channeled portion of (41a) |
| 72 | central channel portion of (41a) |
| 74 | flange-channeled portion of (41b) |
| 76 | flange-channeled portion of (41b) |
| 78 | central channel portion of (41b) |
| 54b | circumferential, cantilevered portion of (54) |
| 54c | circumferential, cantilevered portion of (54) |
| 58b | circumferential, cantilevered portion of (58) |
| 58c | circumferential, cantilevered portion of (58) |
| 52b | divided section of (52) |
| 52c | divided section of (52) |
| 56b | divided section of (56) |
| 56c | divided section of (56) |

### DETAILED DESCRIPTION OF THE PREFERRED EMBODIMENTS OF THE INVENTION

The following description of preferred embodiments of the concepts and teaching of this present invention is made in reference to the accompanying drawing figures which constitute preselected illustrated examples of the structural and functional elements of the present invention, among many other examples existing within the scope and spirit of present invention.

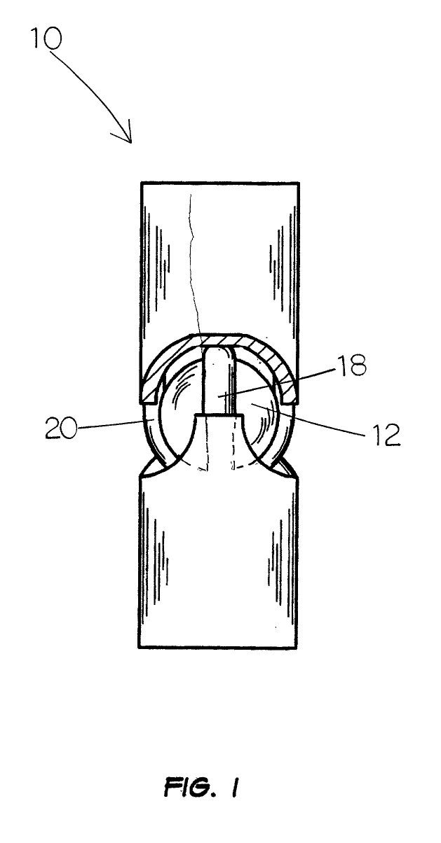

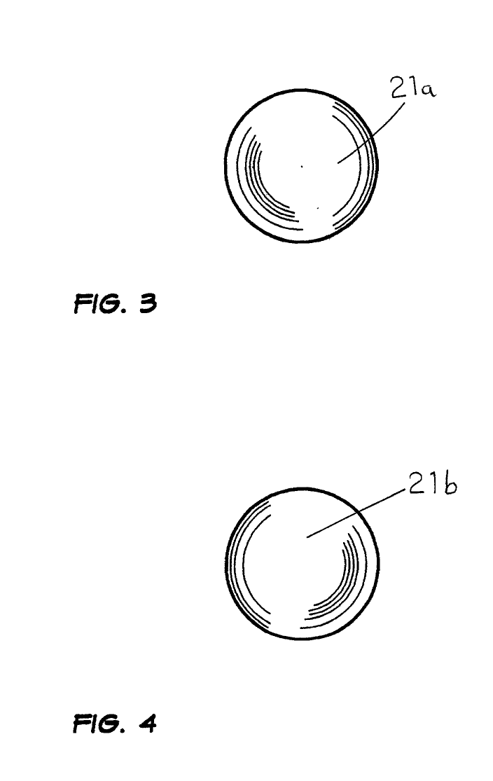

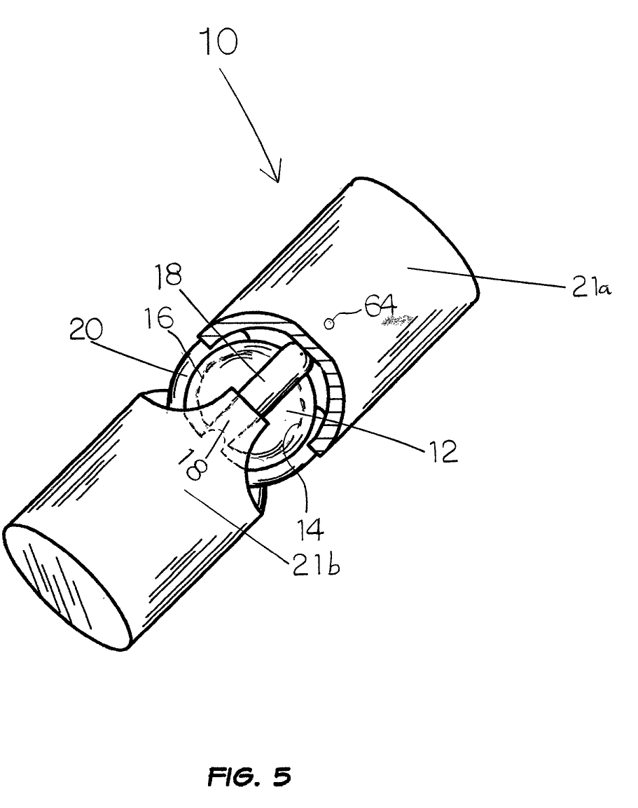

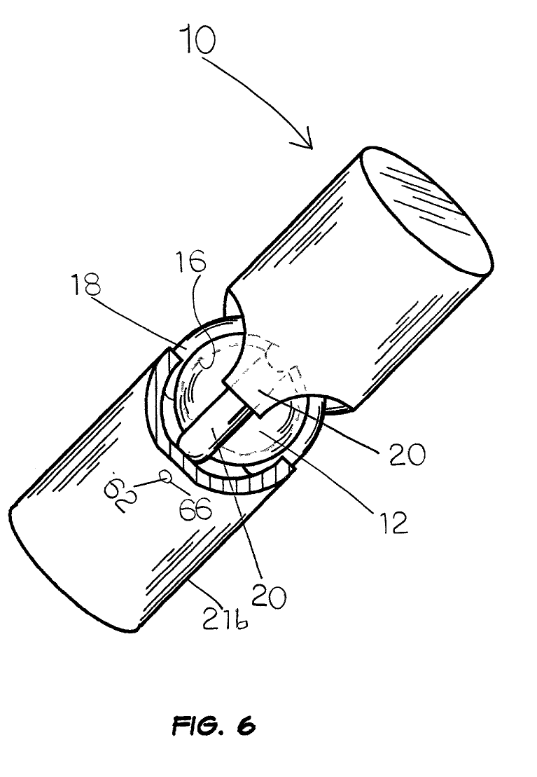

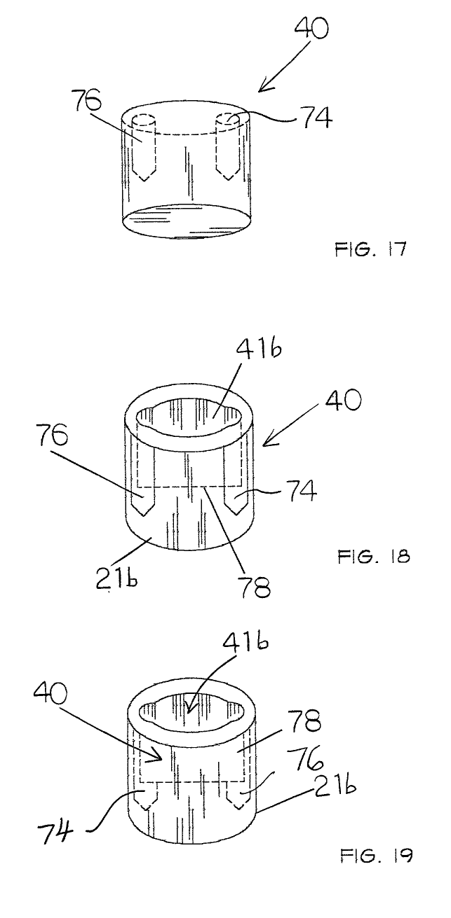

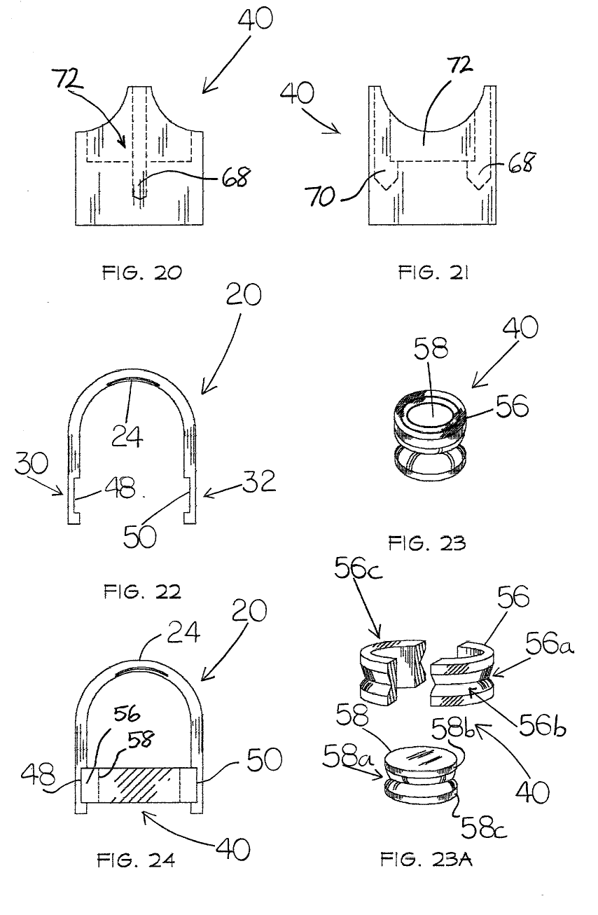

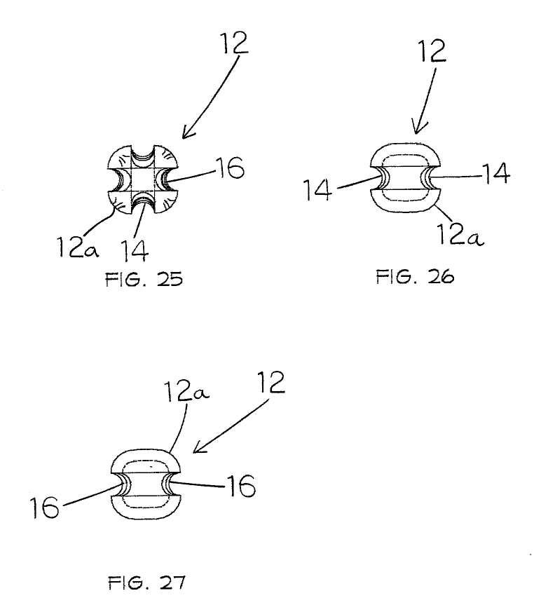

Referring now to the drawings, FIGS. 1 through 27, thereof, there is shown a universal coupling assembly 10, of the present invention, referred to herein as the Universal 10.

The Universal 10 is utilized for use in connecting a number of (more than 1 (one), theoretically a number, but generally 2 (two)) connection members to one another, for transfer of movement, from one or more members to at least one other member (or to a number of other members). In preferred embodiments of the invention, this involves transferring movement from one connection member such as an axial member, for example a drive shaft a steering column member, to another axial member a part of the same or cooperating system; for transfer of movement from at least one positional plane or position to another positional plane or position. The Universal 10 of the present invention can be utilized as in the manner of other universal joints and like connection or couplng members; but is more versatile and efficient, in that it has a wider angle of positioning through which it can generate movement, less operating movement surfacing to wear out, can be constructed of many diverse types of fabrication materials and utilized for a connection where it is the object to provide movement from one positional angle, plane or orientation to another; or, to provide coupling of and movement of each of two members along an angle. The Universal also has the capacity to provide movement from one plane or position to another, and such movement back and forth between two such positions or planes so that movement can be generated from either of two such positions, rather than from only one position or plane, as is so often the case in the prior art universal joints.

The Universal 10 is provided with the positional guide member 12. The guide 12 is provided with channel guides 14 and 16; as illustrated, by example, in FIGS. 1, 5, 6, 7, 10, 25, 26 and 27. Also provided as a part of the Universal 10 are the guide support members 18 and 20; as illustrated, by example, in FIGS. 1, 2, 5, 6, 7, 8, 9, 22 and 24.

Connection members 21a and 21b are shown, by examples only, in FIGS. 1, 2, 3, 4, 5, 6, 7, 8, 14, 15, 16, 17, 18, 19, 20, and 21. It will be understood that a substantial number and different types of connection members, illustrated example as elements 21a and 21b, can be the subject of coupling, connection, attachment, movement and interaction with the Universal 10.

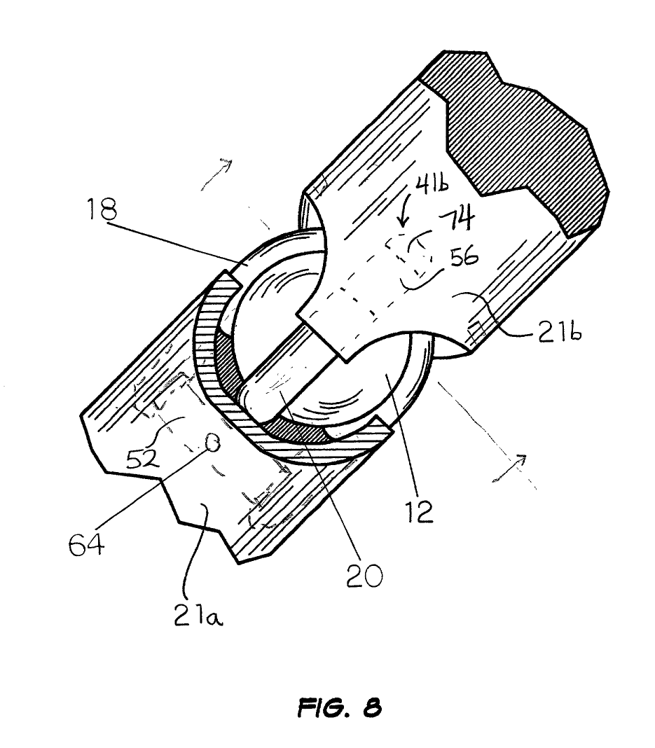

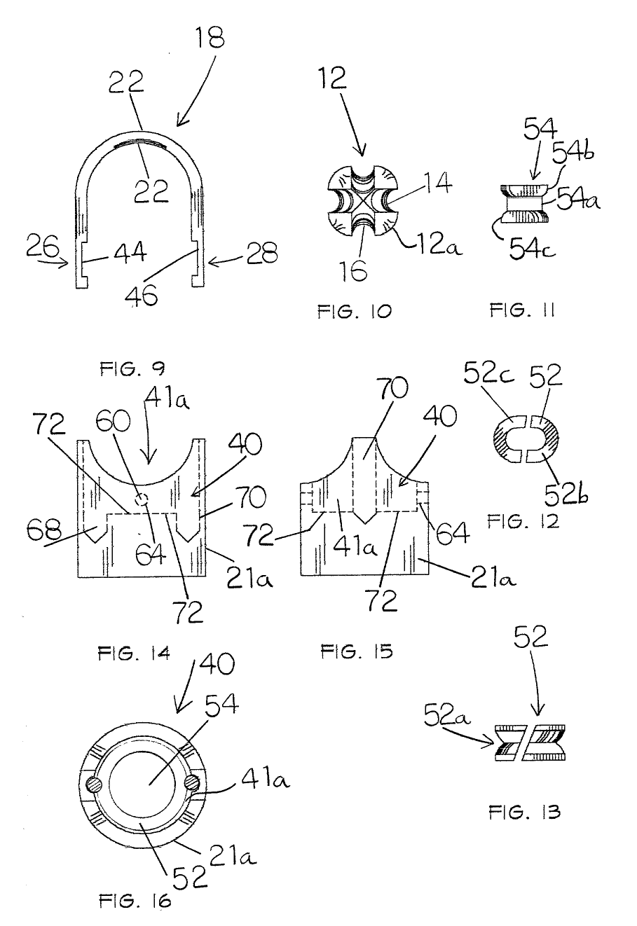

As illustrated, by example, in FIGS. 9, 22, 24 and other drawing illustrations; the guide support members 18 and 20 are, each U-shaped in general or substantial configuration. The guide support member 18 is provided with the cental curved portion 22 and the end portions 26 and 28 The guide support member 20 is provided with the central curved portion 24 and the end portions 30 and 32.

The central curved portions 22 and 24 are each fabricated, constructed, shaped and/or dimensioned so as to fit on, and slidably and securely move within and upon the channel guides 14 and 16 of the positional guide member 12. In so doing, the central curved portion 22 of the guide support member 18 is securely positioned to slide and move in contact with one of the channel guides 14 and 16; and the central curved portion 24 of the guide support member 20 is securely positioned to slide move in contact with the other of the channel guides 14 and 16.

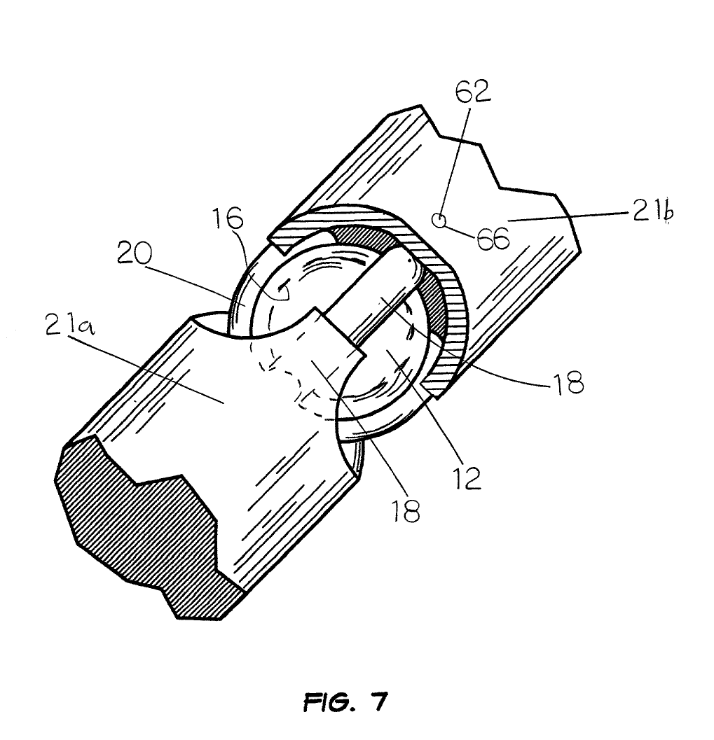

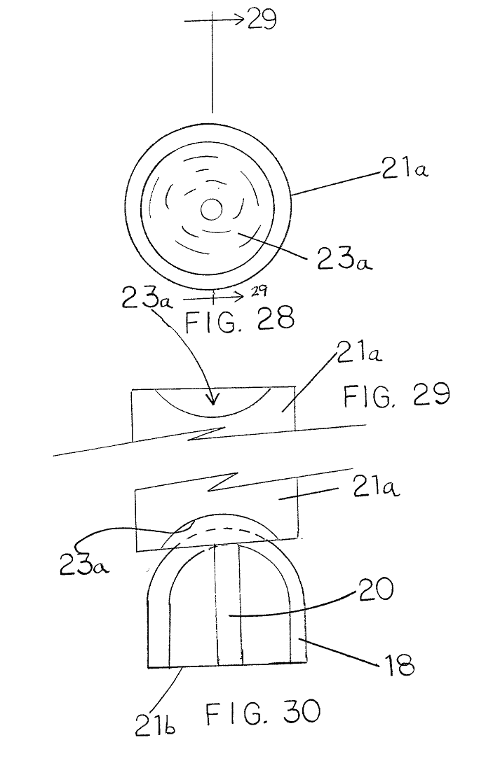

The end portions 26 and 28 of the guide support member 18 are securely attached, in preferred embodiments of the invention, to, and in interaction with, the connection member 21a. The end portions 30 and 32 of the guide support member 20 are securely attached to, and in interaction with, the connection member 21b. In each case the attachment of the guide support members 18 and 20 facilitates movement at an angle between the members 21a and 21b, and also facilitates transfer of movement between these members (21a and 21b). In one preferred embodiment of the Universal 10, each of the members 21a and 21b is, respectively, provided with, or is constructed and fabricated to dimensionally define the hollowed movement area 23a (in member 21a) and the hollowed movement 23b (in member 21b) as illustrated, by example in FIGS. 7, 28, 29; for providing an area within each of the members 21a and 21b, respectively, for the adjacent, corresponding guide support member 20 and 18 to postionally move within, as illustrated.

In other preferred embodiments of the present invention, the Universal 10 is provided with the retainer subassembly means or system, generally delineated and identified as 40, by example, in FIGS. 8, 9, 11, 12, 13, 14, 15, 16, 17, 18, 19, 20, 21, 22, 23, 24 and other drawing illustrations; which is utilized in structural association or interface with the guides support members 18 and 20.

The retainer subassembly system 40 designed, as taught in the present invention, to be utilized in releasable connection and interface with each of the guide support members 18 and 20; to securely, but relesably and interchangeably, facilitate and augment connection and attachment of the support member 18 and 20 to respective connection members 21a and 21b operating interaction with the Universal 10 or forming parts, or integral construction, thereof; or by virtue of retrofitting two such connection members 21a and 21b for use in interaction or combination with the guide support members 18 and 20 of the Universal 10. In this manner, at least two components of a cooperating movement system, such as connection members 21a and 21b, can be linked to and coupled with one another; and at least one such component thereof utilized in relation to at least another such component thereof to augment and facilitate movement from one to the other, and between such components as 21a and 21b.

The retainer subassembly system 40, in preferred embodiments of the present invention, is provided with the port installation area 41a, which is provided and defined, in this embodiment, dimensionally, configurationally and structurally within an end potion of the connection member 21a. The system 40 further comprises the port installation area 41b, which is provided and defined dimensionally, configurationally and structurally within an end potion of the connection member 21b, as illustrated.

The port 21a is dimensioned and shaped to facilitate secure fitting within this port of the end portions 30 and 32 of the adjacent, guide support member 20. The port 21b is dimensioned and shaped to facilitate secure fitting within the port of the end portions 26 and 28 of the adjacent, guide support member 18.

As a part of the retainer subassembly means or system 40, each of the end portions 26 and 28 of the guide support member 18 is provided with, and defines, respectively, the installation notches 44 and 46 (or channeled areas); and each of the end port 30 and 32 of the guide support member 20 is provided with, and defines, respectively, the installation notches 48 and 50 (or channeled areas); as illustrated, by example, in FIGS. 9, 22 and 24. Further, in this aspect, the guide support member 18 is provided with the retainer ring member 52 and the wear pad silencer member 54 and the guide support member 20 is provided with the retainer ring member 56 and the wear pad silencer member 58. The retainer ring member 52 is provided with, or has and defines, the outer channeled circumferential perimeter 52a. The retainer ring member 56 is provided with, or has and defines, the outer channeled circumferential perimeter 56a. In preferred embodiments of the invention, the perimeter 52a and 56a are configured, oriented or shaped in a V-type, U-type channel (or notch) or similar shape and form. around the circumferential periphery thereof, for juxtaposition or biasing, or holding, contact of a set screw or other holding or securing member, discussed later herein. In these aspects set forth in this paragraph the reader is directed to FIGS. 11, 12, 13, 16, 23, 23a, and 24.

Further, in this regard, the wear pad silencer member 54 is installed. as a part of the invention, so that the wear pad silencer member 54 is within and surrounded by the retainer ring member 52. In like manner, the wear pas silencer member 58 is installed so that the member 58 is within and surrounded by the retainer ring member 56. This is illustrated by example in FIGS. 16, 23, 23a, and 24. The wear pad silencer member 54 is provided with, has and defines, the depressed mid flange surfacing 54a, as illustrated generally, by example, in FIG. 11 and other drawing illustrations. In like manner the wear pad silencer member 58 is provided with, has and defines, the depressed mid flange surfacing 58a. It will be understood, in this regard, that a number different configurations and shapes regarding the surfacing's 54a and 58a can be utilized within the scope and spirit of the present invention to accomplish the purpose, thereof, of creating a compatible surfacing on each of the silencer members 54 and 58 to receive the convex, rounded or pointed internal surface of each of the outer channeled circumferential perimeters 52a and 56a, as the alignment is brought into place of the retainer ring member 52 around the wear pad silencer 54; and the retainer ring member 56 around the wear pad silencer 58, as illustrated by example and discussed herein.

Further, in this regard, the ring member 52, with the silencer member 54 installed within it; is, then, installed within the installation notches 44 and 46, respectively, of the end portions 26 and 28 of the guide support member 18. In the manner, the ring member 56, with the silencer member 58 installed within it; is, then, installed within the installation notches 48 and 50, respectively, of the end portions 30 and 32 of the guide support member 20; as illustrated, by example, in FIGS. 16 and 24.

Also, in this regard, the entire retainer subassembly 40 is installed within each of the port installation areas 41a and 41b. In the regard, therefore, the guide support member 18, with the ring member 52, containing the silencer member 54, retained within the notches 44 and 46 of the end portions 26 and 28 of the guide support member 18; is installed within the port installation area 41a of the connection member 21a; as an assembled unit. In like manner, the guide support member 20, with the ring member 56, containing the silencer member 58, retained within the notches 48 and 50 of the end portions 30 and 32 of the guide support member 20; is installed within the port installation area 41b of the connection member 21b; as an assembled unit.

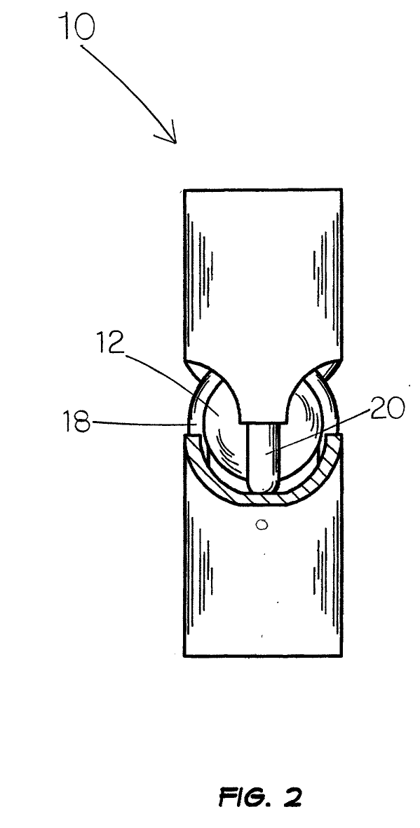

Additionally, in this regard, the set screw 60 of the assembly 40 is brought into contacted, securing and/or biasing alignment and positional orientation with the retainer ring member 52, after installment as a unit as, just above, previously described; so as to hold and secure the entire installed unit, a part of the subassembly 40, in operative position within the connection member 21a. In like manner, in this regard, the sect screw 62 of the subassembly 40 is brought into contacted, securing and/or biasing alignment and positional orientation with the retainer ring member 56, after installment as a unit as, just above, previously described; so as to hold and secure the entire installed unit, a part of the subassembly 40, in fixed operative position within the connection member 21b. As illustrated by example in FIGS. 2, 5, 6, 7, 8, 14, 16, the set screws 60 and 62 are placed in position, respectively, by installing each through the set screw holes 64 and 66; as illustrated. It will be understood, within the scope and spirit of the invention and Universal 10, that a number of other types of releasable, removable and/or uninstall-able securing means can be utilized to hold units of the subassembly 40 in fixed operative position as described; such as pin system means, spot welding means, cementing means, integral or partially integral fabrication or construction of the elements of subassembly 40 described herein, in structural association, with or within the connection members 21a and 21b, or a greater plurality of such connection members.

However, preferred embodiments of the invention, are set forth in the described set screw securement, and installed positional and respective arrangement of the subassembly 40; by virtue of one unit containing elements 18, 44, 46, 52, 54, 60, 64 and 41a; and the other unit containing elements 20, 48, 50, 56, 58, 62, and 41b; each facilitate a functional object of the present invention in these described preferred embodiments to provide releasable and replaceable parts in response to wear and aging in the installed use of the Universal 10.

Each of the wear pad silencer members 54 and 58 is preferably of sphereical (circular or circularly cantilevered) shape or configuration, as illustrated by example in FIGS. 11, 16, 23, and 23; and is fabricated or constructed of nylon, like material, or a material having a resiliency and some or minimal elasticity. As earlier discussed, in part, the members 54 and 58 are, each, provided with the depressed mid flange surfacing's 54a and 58a having one diameter or radius; and two circumferential, cantilevered portions; portions 54b and 54c on either side of surfacing 54a, and portions 58b and 58c on either side surfacing 58a; having a diameter or radius of greater dimensional magnitude that of the respective surfacing's 54a and 58a, as illustrated by example.

Also, each of the retainer ring members 52 and 56 is annular (or ring-like) and circumferential in construction and periphery; in preferred embodiments; and is preferably fabricated or constructed, and operatively utilized, in half, or other divided, sections (or portions) 52b and 52c (sections of member 52), and sections (or portions) 56b and 56c (sections of member 56) as illustrated by example in FIGS. 12, 13, and 23a.

Each of the wear pad silencer members 54 and 58 is constructed and dimensioned to fit positionally within the, corresponding respective, retainer ring members 52 and 56, and to bias the respective sections 52b/52c and 56b/56c against (and flush and secure with) adjoining portions and surface areas of the respective installation notches 44/46 and 48/50, of each of the respective guide support members 18 and 20.

In other related preferred embodiments, the port installation area 41a is formed of, or comprised by, the flange channel portions 68 and 70, and the central channel portion 72. In like manner, the port installation area 41b is formed of, or comprised by, the flange-channeled portions 74 and 76, and the central channel portion 78.

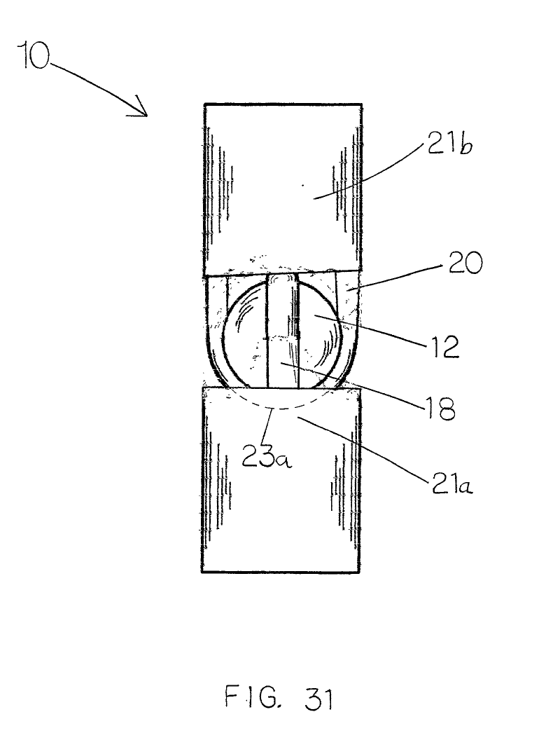

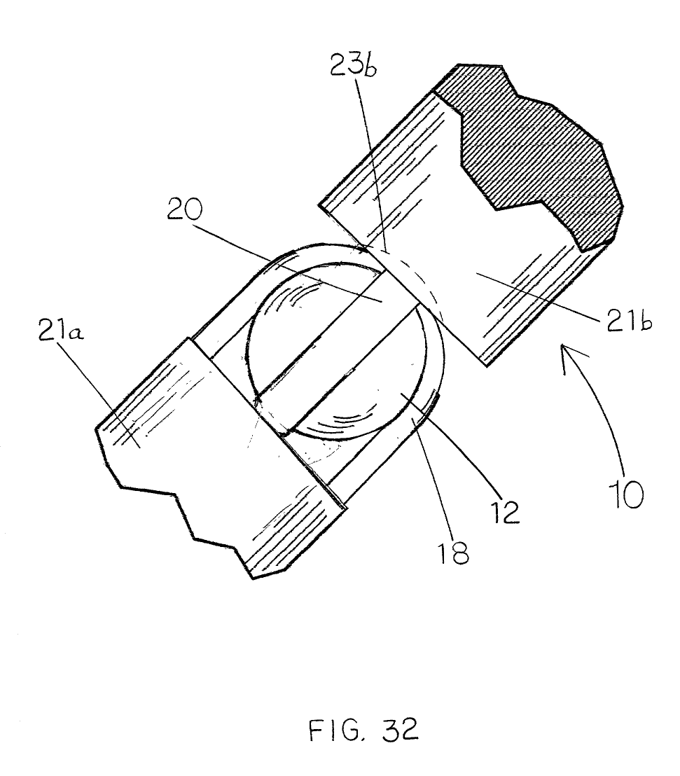

Also provided within the scope of the present invention is the method and process for making and fabricating the Universal 10. This process, in broader preferred embodiments of the invention, comprises the steps of fabricating, constructing or machining the positional guide member 12 so that it has a curved or arcuate periphery surfacing 12a and is generally ball-like or spherically in shape and configuration, as illustrated configurationally by example in FIGS. 1, 2, 5, 6, 7, 8, 10, 25, 26, 30, 31 and 32. The process also comprises channeling (machining, carving or cutting) the channel guide 14 and the channel guide 16 (or first and second slidable or tracking grooves) on and within the periphery surfacing 12a of the guide member 12. This is done so that the guide 14 and the guide 16 are placed at an angle (angle alpha) in relation to one another which, in preferred embodiments of the invention, is generally transverse in character; and are also placed in relation to one anther so that they, in fact, intersect with one another.

The process further comprises fabricating (manufacturing or forming) the guide support member 18 (or guide attachment member) having the central curved portion 22 and the end portions 26 and 28, and configured or shaped in the form of a U-shaped member. And in like manner, fabricating the guide support member 20 having the central curved portion 24 and the end portions 30 and 32. The process portion 22 of the guide support member 18 in contact and around the channel guide 16; and slidably and securely attaching the central curved portion 24 of the guide support member 20 in contact and around the channel guide 14.

The process further comprises releasably attaching the end ports 26 and 28 of the guide support 18 to the connection member 21a; and in like manner attaching the end portions 30 and 32 of the guide support 20 to the connection member 21b.

In further preferred embodiments of the invention the process step of releasably attaching the end portions 26 and 28 of the guide support 18 to the connection member 21a, further includes retrofitting the connection member 21a by the additional process elements of machining (or channeling) the flange channeled portions 70 and 72 so that they are spaced apart from one another and, each, channeled to substantially a first preselected depth; and machining (or channeling) the central channel portion 72 so that it has a diameter generally extending between the axial center point of the flange channel portion 70 and the axial center point of the flange channeled portion 72, and is machined or channeled to a second preselected depth which is less in dimensional magnitude than that of the flange channeled portions 70 and 72. This is illustrated, by example, in FIGS. 14, 15, 17, 18, 19, and 21.

In like manner, the process step of releasably attaching the end portions 30 and 32 of the guide support 20 to the connection member 21b, further includes retrofitting the connection member 21b by the additional process elements of machining (or channeling) the flange channeled portions 74 and 76 so that they are apart from one another and, each, channeled to substantially a first preselected depth; and machining (or channeling) the central channel portion 78 so that it has a diameter generally extending between the axial center point of the flange channeled portion 74 and the axial center point of the flange channeled portion 76, and is machined or channeled to a second preseleted depth which is less in dimensional magnitude than that of the flange channeled portions 74 and 76.

The step in the process of fabricating the guide support member 18, in preferred embodiments, further includes channeling (machining, journalling, cutting, etc.) the installation notch 44 on the end portion 26, and channeling the installation notch 46 on the end portion 28. Also, the step of fabricating the guide support member 20 further comprises channeling the installation notch 48 on the end portion 30, and channeling the installation notch 50 on the end potion 32.

In further related preferred embodiments of the invention, the step within the described process and method, herein, of releasably attaching the end portions 28 and 30 of the guide support member 18 to the connection member 21a; further is composed of or constitutes fabricating the retainer ring member 52, preferably in divided sections 52a and 52c, so as to have the outer channeled circumferential perimeter 52a. The ring member 52 is preferably constructed of semi-flexible (or elastic able) material which can include a number of polymer, materials. The process, in this regard, includes further fabricating the wear pad silencer member 54 (preferably constructed of nylon or similar material, as discussed earlier), so that it has the depressed mid flange surfacing 54a earlier described herein. The wear pad silencer 54 is installed within and inside the retainer ring 52. The retainer ring 52, so fitted, is positioned within and in contact with the installation notch 44 of the end potion 26 and the installation notch 46 of the end portion 28. The process, in this regard, further is composed of releasably installing the end portions 26 and 28 of the guide support member 18, the retainer ring 52 and the wear pad 54 within the port installation area 41a composed of the flange-channeled portions 68 and 70 and the central channel port 72 of the connection member (or retrofitted connection member) 21a.

Further, the step within the described process of releasbly attaching the end portions 30 and 32 of the guide support 20 to the connection member 21b comprises fabricating the retainer ring member 56, preferably in divided sections 56b and 56c, so as to have the outer channeled circumferential perimeter 56a. The ring member 56 is preferably constructed of semi-flexible (or elastic able) material which can include a number of polymer, plastic or similarly resilient and at least partly or partially elastic constructive materials. The process, in this regard, includes further fabricating the wear pad silencer member 58 (preferably constructed of nylon or similar material, as discussed earlier), so that it has the depressed mid flange surfacing 58a earlier described herein. The wear pad silencer 58 is installed within and inside the retainer ring 56. The retainer ring 56, so fitted, is positioned within and in contact with the installation notch 48 of the end portion 30 and the installation 50 of the end portion 32. The process, in this regard, further is composed of releasably installing the end portions 30 and 32 of the guide support member 20, the retainer ring 56 and the wear pad 58 f(fitted within the ring 56) within the port installation area 41b composed of the flange-channeled portions 74 and 76 and the central channel portion 78 of the connection member 21b.

The retrofitting of the connection member 21a of the process, in preferred related embodiments of the present invention, further is composed if channeling (machining or forming) the set screw hole 64, or one or more such holes, so that it communicates between the outside periphery (or surfacing) of the connection member 21a and the port installation area 41a of the member 21a. The set screw 60 is installed in (screwed, hammered or otherwise securely engaged within) the set screw hole 64 so that the screw 60 securely biases or presses against (or otherwise, securely makes contact with) the releasably installed retainer ring 52 (preferably sectioned, and as earlier described). In so doing, this assists, augments or accomplishes, securely holding the entire retainer subassembly 40, as utilized in the connection member 21a, in installed and operative position; and facilitates later desired or preselected withdrawal of the screw 60 (or like member, as earlier described herein) for examination and/or replacement of guide support member 18, the ring 52, the pad 54 or the screw 60, itself; so that the entire Universal 10 does not have to be replaced under conditions when wear, tear, aging (or like deterioration) takes place during operative use of the Universal 10 of the present invention.

In like manner, the retrofitting of the connection member 21b of this process, specifically linked to the manufacture, construction and/or fabrication of the Universal 10 of the present invention, further is composed of channeling the set screw hole 66, or one or more such holes, so that it communicates between the outside periphery of the connection member 21b and the port installation area 41b of the member 21b. The set screw 62 is installed in the set screw hole 66 so that the screw 62 is installed in the set screw hole 66 so installed retainer ring 56. In so doing, as earlier indicated, this augments securely holding the entire retainer subassembly 40, as utilized in the connection member 21b, in installed and operative position; and facilitates later entry for examination or replacement of elements or parts (as similarly earlier described).

The use of various kinds resilient and at least partly elastic constructive materials for elements of the retainer subassembly 40 has previous been discussed. It will also be understood that it is well within the scope and spirit of the Universal 10 of the present invention to utilize a number of preselected (or otherwise determined) dimensional applications in structuring, using, fabricating and/or manufacturing the present Universal 10 and its elements set forth and described herein. In this regard, the following table (Table 1), showing generally descriptive icon-like reference illustrations, sets forth some of the dimensional and configurational considerations and applications as examples of such information contained within the scope and spirit of the invention, and its stature and related process or method of fabricating or manufacturing elements of the present invention. It will be understood that these illustrated exemplar configurational and dimensional considerations within the scope of the Universal 10, also carry over to other elements of the invention not specifically set forth, by example, in Table 1.

[image]

Accordingly, the appended claims are intended to cover all changes, modifications and alternative options and embodiments falling within the true breath, scope and spirit of the present invention. The reader is, therefore, requested to determine the scope of the invention by the appended claims and their legal equivalents, and not by the examples which have been given.

What is claimed is:

1. A universal and coupling assembly for use in connecting a plurality of connection members to one another, for transfer of movement, therebetween, and from at least one positional plane to another positional plane, therebetween; said universal and coupling assembly having a spherical positional guide member, positionally oriented to interface between, and connect, a plurality of connection members, the spherical positional guide member defining a channeled and grooved outer periphery surface, having a plurality of channels, each, defined in relation to one another along an arcuate and circumferential periphery; and further having a plurality of guide support members, each of which is slidably and positionally oriented in relation to at least one of the, respective, channels, and attached to at least one of a plurality of connection members.

2. The universal and coupling assembly of claim 1, wherein:
said plurality of channels comprises a first channel groove and a second channel groove; and said plurality of guide support members comprises a first guide support member and a second guide support member.

3. The universal and coupling assembly of claim 2, wherein:
each of said guide support members further comprises first and second ends, and a U-shaped portion, connecting the first and second ends, the U-shaped portion defining an arcuate periphery which is positionally and slidably compatible with at least one of said first and second channel grooves.

4. The universal and coupling assembly of claim 3, wherein:
the first and second ends of the first guide support member are attached to one of a plurality of connection members, and the first and second ends of the second guide support member are attached to another one of a plurality of connection members, for transmitting positional movement therebetween; and wherein:
the U-shaped portion of the first guide support member is securely and slidably positioned in contact with the first channel groove, and the U-shaped portion of the second guide support member is securely and slidably positioned in contact with the second channel groove.

5. The universal and coupling assembly of claim 4, wherein:
each of the first and second guide support members further comprises subassembly means for releasably and interchangeably attaching to one of a plurality of connection members.

6. The universal and coupling assembly of claim 5, wherein:
said assembly further comprises at least first and second connection members, the first connection member defining a port installation area for communication with, and installation of, the subassembly means of the first guide support member, and the second connection member defining a port installation area for communication with, and installation of, the subassembly means of the second guide support member.

7. The universal and coupling assembly of claim 6, wherein:
each of the subassembly means of the first and second guide support members, comprises: a retainer member and a wear-pad silencer member, the wear-pad silencer member being positionally installed within, and surrounded by, the retainer member; wherein:
the first and second ends of each of the first and second guide support members, each, define a channeled area positionally and dimensionally configured to installably receive one of the retainer members of one of the subassembly means of said first and second guide support members; and wherein:
the port installation area of each of the first and second connection members, is further defined by first and second flange-channeled portions, and a central channel portion.

8. The universal and coupling assembly of claim 7, wherein:
each of the wear-pad silencer members is of spherical configuration and nylon fabrication; wherein:
each of the retainer rings is annular and circumferential in construction and periphery, further comprising first and second arcuate portions, when viewed cross-sectionally, and defining a notch about its circumferential periphery; and wherein:
each of the wear-pad silencer members is constructed and dimensioned to fit positionally within the, corresponding respective, retainer ring, and to bias the first and second arcuate portions thereof against respective adjoining portions of each of the channeled areas of each of the guide support members.

9. A universal and coupling assembly for use in connecting a first member to a second member for the purpose of transferring movement therebetween from a first position or plane to a second position or plane between the first and second members, said universal and coupling assembly comprising:
first and second connection members;
a spherical positional guide member, said spherical positional guide member defining at least a first channel guide track and a second channel guide track, the first channel guide track being at an angle alpha in relation to the second channel guide track, and intersecting therewith,
a guide support member attached to the first connection member,
a guide support member attached to the second connection member,
the guide support member of the first connection member being retainably and guidably attached to the first channel guide track, and the guide support member of the second connection member being retainably and guidably attached to the second channel guide track, such that the first connection member can retainably move in positional relation to the second connection member;
whereby the spherical positional guide member is securely and retainably supported adjacent to, and between, the first and second connection members for securely guiding positional movement therebetween, while securely retaining the first and second connection members in movable positional relation to one another.

10. The universal and coupling assembly of claim 9,
wherein:
the first member defines an installment and movement port for secure positioning and movement of the guide support member of the second member, and secure and releasable attachment of the guide support of the first member; and
the second member defines an installment and movement port for secure positioning and movement of the guide support member of the first member, and secure and releasable attachment of the guide support member of the second member.

11. The universal and coupling assembly of claim 10,
wherein:
the guide support members of the first and second members are, each, U-shaped in configuration, having a central curved portion and first and second end portions, and define arcuate and curved circumferential side walls.

12. The universal and coupling assembly of claim 11,
wherein:
the first channel guide track and the second channel guide track are, each, curved and arced in depth and configuration, for moveable receipt and slidable contact of the first and second guide members, respectively; and wherein:
the angle alpha comprises from about 40 degrees to about 50 degrees.

13. The universal and coupling assembly of claim 12,
wherein:
the first and second end portions of the guide support member of the first member, each, define an installment clip slot, and
the first and second portions of the guide support member of the second member, each, define an installment clip slot.

14. The universal and coupling assembly of claim 13,
wherein:
the first member further comprises a retainer subassembly means for securely and releasably attaching and installing each of the, respective, first an second portions of the guide support member of the first member into and within the installment and movement port of the first member.

15. The universal and coupling assembly of claim 14,
wherein:
the second member further comprises a retainer subassembly means for securely and releasably attaching and installing each of the respective, first and second portions of the guide support member of the second member into and within the installment and movement port of the second member.

16. A method and process for making and fabricating a universal joint and coupling assembly, of the type utilized to connect and transfer movement and motion from, and between, a first movable member to a second movable member, comprising the steps of:
fabricating a spherical member having a curved surface;
channeling a first slidable groove and a second slidable groove on and within the curved surface of the spherical member, such that the first slidable groove and the second slidable groove are placed at an angle alpha in positional relation to one another, and intersect with one another;
fabricating a first U-shaped guide attachment member having a central arcuate portion and first and second end portions;
fabricating a second U-shaped guide attachment member having a central arcuate portion and first and second end portions;
slidably and securely attaching the central arcuate portion of the first U-shaped guide attachment member to, and around, the second slidable groove, and slidably and securely attaching the central arcuate portion of the second U-shaped guide attachment member to, and around, the first slidable groove.

17. The method and process of claim 16, further comprising the step of:
releasably attaching the first and second end portions of the first U-shaped guide attachment member to a first movable member, and releasably attaching the first and second end portions of the second U-shaped guide attachment member to a second movable member.

18. The method and process of claim 17, wherein the step of releasably attaching the first and second end portions of the first U-shaped guide attachment member to a first movable member, further comprises retrofitting the first movable member, comprising: boring first and second holes, being spaced apart from one another and, each, being counter-bored to, generally, a first depth, and boring a third hole having a diameter extending between the axial center point of the first hole an the axial center point of the second hole and being counter-bored to, generally, a second depth which is less in dimensional magnitude than that of the first and second holes, whereby first and second arced slot portions are thereby fabricated and configured.

19. The method and process of claim 18, wherein the step of releasably attaching the first and second and portions of the second U-shaped guide attachment member to a second movable member, further comprises retrofitting the second movable member, comprising: boring first and second holes, being spaced apart from one another and, each, being counter-bored to, generally, a depth, and boring a third hole having a diameter extending between the axial center point of the first hole and the axial center point of the second hole ad being counter-bored to, generally, a second depth which is less in dimensional magnitude than that of the first and second holes, whereby first and second arced slot portions are thereby fabricated and configured.

20. The method and process of claim 19, wherein the step of fabricating a first U-shaped guide attachment member, further comprises channeling an installation notch on the first end portion thereof, and channeling an installation notch on the second end portion thereof; and the step of fabricating a second U-shaped guide attachment member, further comprises channeling an installation notch on the first end portion thereof, and channeling an installation notch on the second end portion thereof.

21. Th method and process of claim 20, wherein the step of releasably attaching the first and second portions of the firs U-shaped guide attachment member to a first movable member further comprise fabricating a sectioned retainer ring having an outer channeled circumferential perimeter and being constructed of a semi-flexible material, and further fabricating a spherical nylon wear pad having an outer channeled circumferential perimeter; installing the spherical nylon wear pad within and the sectioned retainer ring; positioning and installing the sectioned retainer ring, and spherical nylon wear pad therewithin, within and in contact with the installation notch of the first portion and the installation notch of the second end portion; and releasably installing the first and second end portions of the first U-shaped guide attachment member, the sectioned retainer ring and the spherical nylon wear pad within the first and second arced portions and the third hole of the first movable member.

22. The method and process of claim 21, wherein the step of releasably attaching the first and second portions of the second U-shaped guide attachment member to a second moveable member further comprises a fabricating a sectioned retainer ring having an outer channeled circumferential perimeter and being constructed of a semi-flexible material, and further fabricating a spherical nylon wear pad having an outer channeled circumferential perimeter; installing the spherical nylon wear pad within and inside the sectioned retainer ring positioning the sectioned retainer ring, and the spherical nylon wear pad therewithin, within and in contact with the installation notch of the end portion and the installation notch of the second end portion; and releasably installing the first and second end portions of the second U-shaped guide attachment member, the sectioned retainer ring and the spherical nylon wear pad within the first and second arced portions and the third hole of the second movable member.

23. The method and process of claim 22, wherein said retrofitting of said first movable member, further comprises boring at least one set screw hole such that it communicates between an outside periphery portion of the first movable member and the third there and installing in a set screw into the set screw hole such that it presses against and biases the releasably installed, sectioned retainer ring; and wherein said retrofitting of said second movable member, further comprises channeling at least one set screw hole such that it communicates between an outside periphery portion of the second movable member and the third hole thereof and installing a set screw into the set screw hoe such that it presses against and biases the releasably installed, sectioned retainer ring.
